(19) United States
(12) Patent Application Publication
(10) Pub. No.: US 2020/0090097 A1
(43) Pub. Date: Mar. 19, 2020

(54) PROVIDING USER WORKFLOW ASSISTANCE

(71) Applicant: INTERNATIONAL BUSINESS MACHINES CORPORATION, ARMONK, NY (US)

(72) Inventors: David J. Nice, Hampshire (GB); Doina L. Klinger, Winchester (GB); Fenglian Xu, Hampshire (GB); Rebecca M. Quaggin-Mitchell, Hampshire (GB)

(21) Appl. No.: 16/131,114

(22) Filed: Sep. 14, 2018

(51) Int. Cl. G06Q 10/06; H04L 29/08; G06F 17/27; G06F 17/30; G06F 17/15

(52) U.S. Cl. CPC G06Q 10/06316; H04L 67/22; G06F 17/15; G06F 17/30887; G06F 17/27

(57) ABSTRACT

Method and system are provided for providing user workflow assistance in a web browser session. The method includes: receiving from a user a declaration of a root activity in the web browser as the root of a workflow and extracting some content from a web page of the root activity; and monitoring a user activity in the web browser session and determining that a new activity in the web browser is activated by a user. The method includes: determining a correlation of the new activity with the root activity by extracting some content from the web page of the new activity and comparing it to the content of the root activity; and, if the correlation is above a threshold, saving the activity in the workflow to build a series of ordered activities.

### BACKGROUND

The present invention relates to providing user workflow assistance, and more specifically, to providing user workflow assistance in a web browser.

Applications are available that support a user workflow. For example, business process management is designed to support corporate performance by managing and optimizing a company's business processes. Other custom domain applications are available. For example, a mortgage advisor or insurance claim assessor uses applications that have knowledge of the states a mortgage or a claim can be in and assists the user in navigating these states. Other tools can be customized to support a certain workflow, to represent the states a user story can be in and give assistance to the user when navigating these states.

What these applications have in common is that the user is using one application to control the processing states and the states of the processes have been either coded in or configured by an administrator.

Often workflows occur when a user is using a web browser to access web pages and web applications. When completing a particular activity a user will often use many different web pages as they progress through initial research, looking into specific issues, choosing between several solutions. However, often a user is working on more than one activity at once or will be distracted by unrelated activities such as checking social media or buying products.

Pulling out the relevant actions for a particular activity that a user completed within the browser is not currently easy as the user might have multiple browser windows and multiple tabs within each window. Some users will keep related tabs together, but this is not universally so. Some applications spawn browser tabs into the last used browser window, which can also lead to confusion.

### SUMMARY

According to an aspect of the present invention there is provided a computer-implemented method for providing user workflow assistance in a web browser session, comprising: receiving from a user a declaration of a root activity in the web browser as the root of a workflow and extracting some content from a web page of the root activity; monitoring a user activity in the web browser session and determining that a new activity in the web browser is activated by a user; determining a correlation of the new activity with the root activity by extracting some content from the web page of the new activity and comparing it to the content of the root activity; and, if the correlation is above a threshold, saving the activity in the workflow to build a series of ordered activities.

According to an aspect of the present invention there is provided a system for providing user workflow assistance in a web browser session, comprising: a processor and a memory configured to provide computer program instructions to the processor to execute the function of components; a workflow building component including: a root activity component for receiving from a user a declaration of a root activity in the web browser as the root of a workflow and a root extraction component for extracting some content from a web page of the root activity; a first monitoring component for monitoring a user activity in the web browser session and a new activity component for determining that a new activity in the web browser is activated by a user; a correlation component for determining a correlation of the new activity with the root activity including an activity extraction component for extracting some content from the web page of the new activity and a comparing component for comparing it to the content of the root activity; and, a saving component for, if the correlation is above a threshold, saving the activity in the workflow to build a series of ordered activities.

According to an aspect of the present invention there is provided a computer program product for providing user workflow assistance in a web browser session, the computer program product comprising a computer readable storage medium having program instructions embodied therewith, the program instructions executable by a processor to cause the processor to: receive from a user a declaration of a root activity in the web browser as the root of a workflow and extract some content from a web page of the root activity; monitor a user activity in the web browser session and determine that a new activity in the web browser is activated by a user; determine a correlation of the new activity with the root activity by extracting some content from the web page of the new activity and compare it to the content of the root activity; and, if the correlation is above a threshold, save the activity in the workflow to build a series of ordered activities.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of an aspect of a method in accordance with the present invention;

FIG. 2 is a flow diagram of an example embodiment of another aspect of a method in accordance with the present invention;

FIGS. 3A to 3C are example workflow series illustrating aspects in accordance with the present invention;

FIG. 4 is block diagram of an example embodiment of a system in accordance with the present invention;

FIG. 5 is a block diagram of an embodiment of a computer system or cloud server in which the present invention may be implemented;

FIG. 6 is a schematic diagram of a cloud computing environment in which the present invention may be implemented; and

FIG. 7 is a diagram of abstraction model layers of a cloud computing environment in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

A method and system are provided for providing user workflow assistance across multiple activities in a web browser.

A user session on a web browser of a computer may involve multiple activities. An activity may involve accessing a web page, web application or service, in which a Uniform Resource Locator (URL) is used to access a remote resource.

A web browser accesses information on the World Wide Web by reference to distinct URLs enabling browsers to retrieve and display resources on a user's device. Most web browsers allow a user to open multiple pages at the same time, either in different browser windows or in different tabs on the same window.

A web page may be retrieved and displayed and may be a static web page that is delivered to the user as it is stored or a dynamic web page that is generated by a web application. Dynamic web pages enable the web browser to enhance the web page through user input to the server.

The URL is a reference to a web resource that specifies its location on a computer network and a mechanism for retrieving it. The URL specifies a protocol scheme and additional hierarchical components.

The method monitors a user during the course of their workflow activities in a web browser and saves a workflow. The workflow may then be used to provide suggestions for the user when involved in a similar workflow.

The workflow may be built by monitoring the user's activities and determining a correlation of an activity with a root activity to extract the important activities from the actual activities carried out during a session.

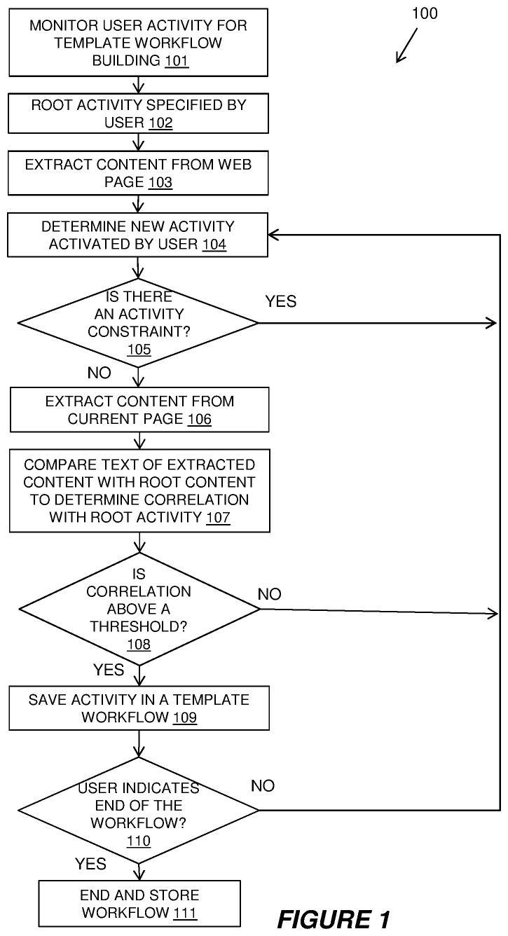

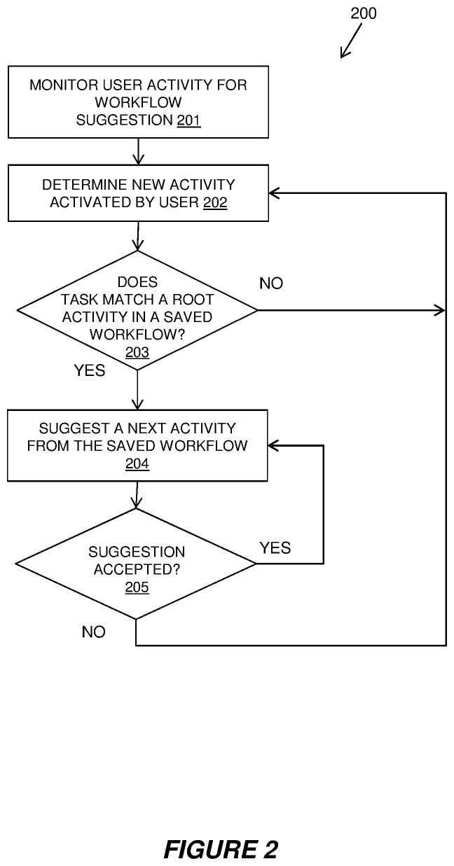

The method includes two aspects: a learning and correlation aspect, an example of which is described with reference to FIG. 1, and a suggestion aspect, an example of which is described with reference to FIG. 2.

When the user completes a task in the form of a workflow that involves visiting a number of web pages, it is useful to archive their train of thoughts. Such an archive may be used for lots of reasons including reminding the user of their solution, helping to organize their browser history by task, allowing other people to follow a similar train of thought, or in some cases replicating a similar process for a different task.

Referring to FIG. 1, a flow diagram 100 shows an example embodiment of a method of building a workflow.

The method monitors 101 a user activity in order to build a workflow. The method may receive a user input specifying a root 102 on which a workflow is to be based thereby activating the monitoring of subsequent activities in the web browser. The method stores the domain and parameters such as the URL suffix.

The method may extract 103 the content from the web page of the root activity. This may be carried out by using a known tool for content extraction such as a web scraper or other tool for extracting web content.

The method may determine 104 that a new activity is activated by the user. This may be the navigation to a new web page in the same window, a new tab, or another window.

The method may determine 105 if there is an activity constraint for the activity. Activity constraints may be predefined for activities that are to be ignored in a workflow. For example, a domain constraint may refer to certain pages that can be ignored such as those relating to social media domains. If there is an activity constraint for the current task, the method may loop to determine 104 that the user has activated a next activity.

If there is no activity constraint, the method may extract 106 the content from the activity and may compare 107 the text of the extracted content with the text of the extracted content of the root activity to obtain a correlation value. This comparison may be carried out by a text similarity tool, including Natural Language Processing tools and Machine Learning technologies.

In another embodiment, the correlation value may also be based on the current activity content being compared to the immediately preceding activity content if it has been saved to the workflow or more than one previous saved activity content. This may be used to refine the correlation value.

In a further embodiment, the user may designate another activity during the workflow that is used as an addition comparison basis in addition to the root activity for the subsequent correlations. This may apply if a particularly relevant web page is used during the workflow.

The method may determine 108 if the correlation value is above a predefined threshold value. If the correlation is above the threshold, the activity may be saved 109 in the workflow.

The threshold value may be configured to provide adjustment to the relevance of activities saved in the workflow. If the user considers that too many activities are being saved in the workflow, she may configure a higher threshold to limit the number of activities that are saved. The activity may be saved with a suggestion of actions (copy summary, mention owner of action etc.). Saving the activity may save a Uniform Resource Locator with a generalized path.

If the correlation of an activity is below the threshold, the activity may be unrelated to the workflow and the activity may be ignored and the method may determine 104 a next activity activated by the user that may potentially be added to the template workflow.

It may be determined 110 if a user has indicated an end to the workflow. If it is not the end of the workflow, the method may loop to determine 104 a next activity activated by the user that may potentially be added to the workflow.

If the user has indicated an end to the workflow, the workflow may be ended and stored 111 for future use. For example, this may be stored in the web browser and the user may be prompted to name the workflow for future use. The ordered list of web pages with its associated activity descriptions related to the root activity may be stored.

When users perform a process they often visit many web pages to find out relevant information. During this stage users may visit some irrelevant pages for many reasons. The method computes the most relevant pages based on content to store the workflow pages. At each new page or tab, the method may compute a correlation score with a root page. If the correlation is high and other domain constraints are satisfied, the method adds it as a possible next step, optionally with a suggestion of actions. This workflow can be used the next time the user needs to perform similar processes.

In one embodiment, a user declares a page to be the beginning of a template workflow. The method may store the domain and parameters such as the URL suffix in the workflow. When the user opens a new page, the method computes a correlation with the initial workflow page. If the correlation is above the threshold, the page is added to the workflow; otherwise, the page is ignored. When user declares the end of the flow, an ordered list of web pages with its associated activity descriptions related to this workflow may be stored in the system.

As time passes a list of workflows with each associated list of related pages is built up in the system. This system can be updated and refined with users' experiences, and can be used to assist users to perform workflow activities in the future.

The method may build a dynamic workflow based on observed user actions, correlation scores, and recommended actions.

Referring to FIG. 2, a flow diagram 200 shows an example embodiment of a method of using a template workflow.

The method may monitor 201 a user activity to provide workflow suggestions. The user may activate a workflow suggestion tool to provide activity suggestions based on saved template workflows. The monitoring may be selectively activated by the user when they wish to use this functionality.

The method determines 202 that a new activity is activated by the user and determines 203 if the activity matches a root activity in a saved workflow. The match may be where a new activity is similar to the root activity. This may be determined by comparing a URL of the new activity with the saved root activity URL whilst disregarding some of the locator path suffix to generalize the URL.

The user does not need to know which workflow is required as the activity matching process may select appropriate workflows. If there is no match, the method may determine 202 when a new activity is activated by the user and may attempt to match the new activity. If there is more than one workflow match, more than one suggestion may be provided to the user.

If the suggestion is accepted 205, the method may suggest 204 a next activity in the same saved workflow so that the user can follow the workflow process. If the suggestion is not accepted, the method may loop to determine 202 when a new activity is activated by the user in order to try to match the next activity.

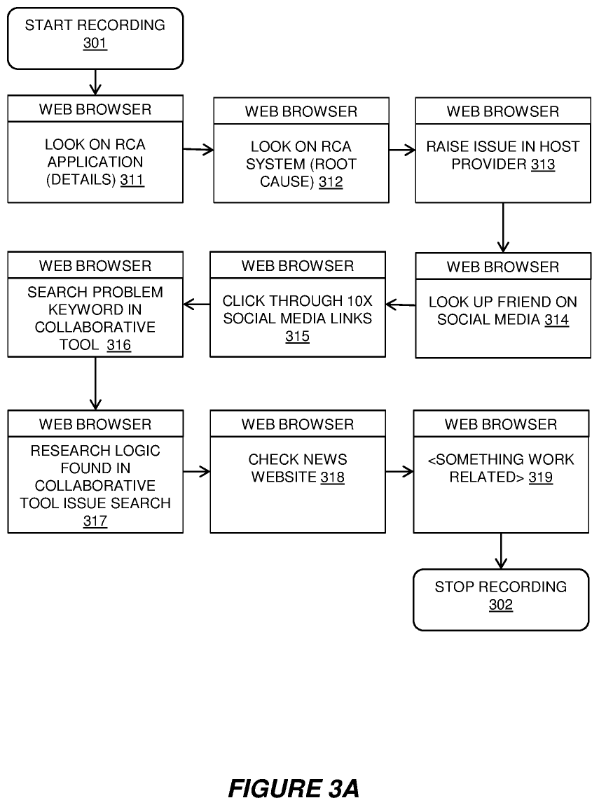

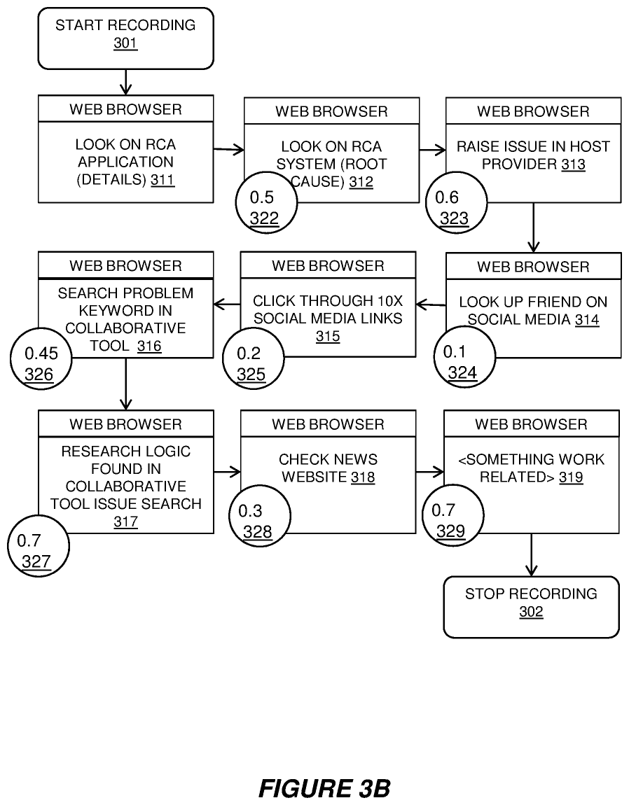

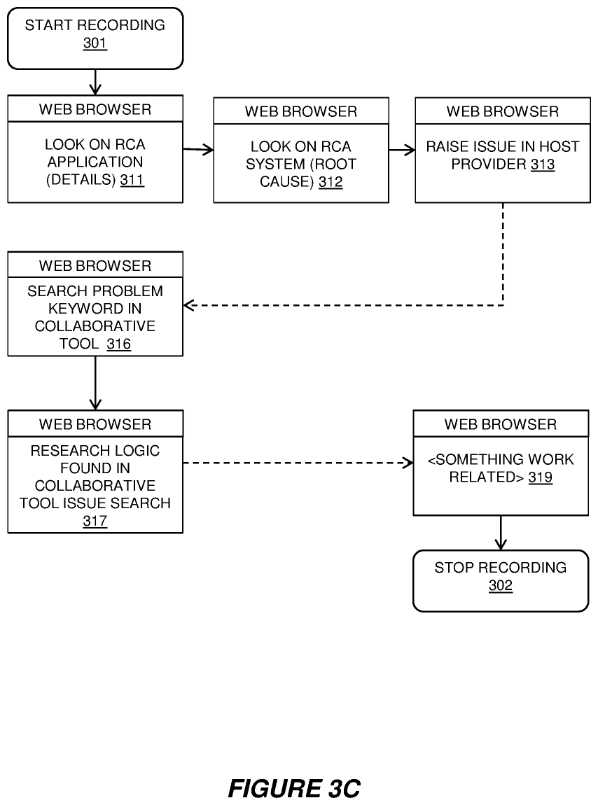

Referring to FIGS. 3A to 3C, an example scenario is shown of a workflow being built from user interactions with a web browser.

FIG. 3A shows a workflow of web browser activities 311-319 carried out by a user in a session in which the user is attempting to solve a software problem report.

As a first activity 311 may look up a root cause analysis (RCA) application for the problem report that the user is working on and may declare this as a root activity. The system may start recording 301 a user's activity in a session and the first activity may be declared by a user to be a root activity.

A second activity 312 may look up an RCA system. A third activity 313 may raise an issue against a hosting or infrastructure provider 313. A fourth activity 314 may look up a person on social media and a fifth activity 315 may click through 10 social media links. The sixth activity 316 may search a problem keyword in a web based collaborative developer tool, and a seventh activity 317 may research logic found in the collaborative tool and issue a search. An eighth activity 318 may check a news website and a ninth activity may read something work related on a news website. The method may then stop recording 302 the workflow.

FIG. 3B shows the same session workflow with correlation scores for each activity that are determined by comparing extracted content from the root activity web page and the current activity web page and carrying out a text similarity analysis. The second activity 312 has a high correlation score 322 of 0.5 with the first activity 311 as they both relate to the same look up of an RCA. The third activity 313 has a high correlation 0.6 of 323 as it is also related to the same subject-matter issue.

The fourth activity 314 has a low correlation score 324 of 0.1 as it is an unrelated activity of looking up a person on social media. The fifth activity 315 has a low correlation score 325 of 0.2 as it relates to clicking through social media links.

The sixth activity 316 has a fairly low correlation 326 of 0.45 as the problem is being searched in a collaborative tool. The seventh activity 317 has a high correlation 327 of 0.7 as the activity researches the topic found in the collaborative tool and therefore has a high correlation with the subject-matter of the root activity. The eighth activity 318 has a low correlation 328 of 0.3 as it is again unrelated as the user looks at a new website; however, the ninth activity 319 has a high correlation 329 of 0.7 as something work related comes up on the news website.

The correlation template is set at 0.4 in this example and FIG. 3C shows the workflow as a saved template with the irrelevant activities 314, 315, 318 with the low correlations removed.

In the described method, the generated workflow may be saved and when the user opens a new page, the method searches through the lists of workflows for a partial match between URLs. For example, the user might open:

https://somehost.com/rca/RCA20170731T165101#rcaRootcause

The method has in its workflow definition a page that was declared as a root activity:

https://somehost.com/rca/RCA20170313T234501#rcaRootcause

The method identifies the newly opened page as an instance of the root activity in a saved workflow.

The method may then provide recommendations of the nature “Last time when you visited somehost.com you next visited https://somesolutionhost.com/Cloud-Integration/hip-ops-incidents/issues/”.

An operator role may be shared across the team where the team members have various degrees of experience. The method can be used to transfer the knowledge, without explicit documents written down, but by observing an experienced user. Any non-relevant activities are filtered out and are not incorporated into the workflow. The method provides identification of workflows with a small input from the user with the system computing correlations.

The described method uses a general purpose tool rather than a workflow development system.

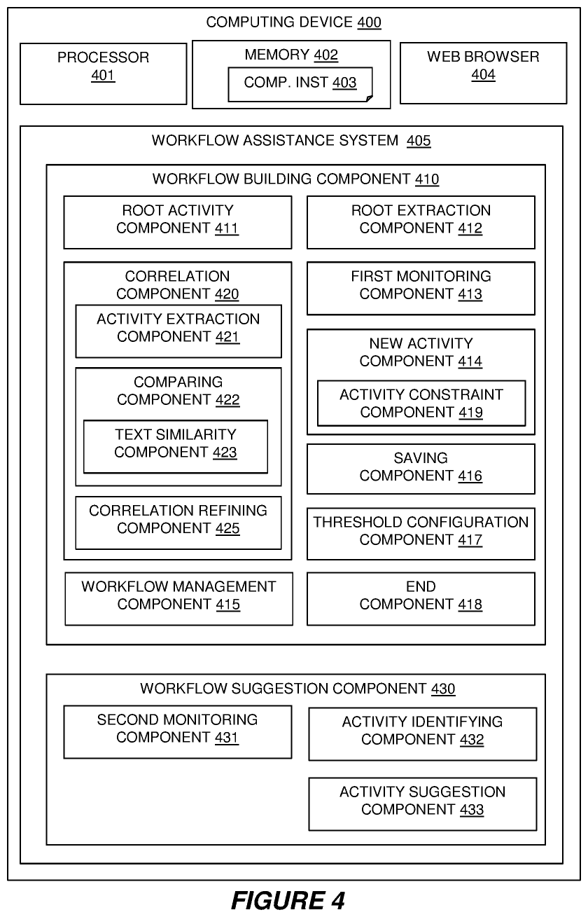

Referring to FIG. 4, a block diagram shows an example embodiment of a computing device 400 in which a workflow assistance system 405 is provided.

The computing device 400 may include at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The workflow assistance system 405 may be incorporated into a web browser 404 or provided as an extension to a web browser 404 for providing user workflow assistance in a web browser session and may include a workflow building component 410 and a workflow suggestion component 430.

The workflow building component 410 may include a root activity component 411 for receiving from a user a declaration of a root activity in the web browser as the root of a workflow and a root extraction component 412 for extracting some content from a web page of the root activity.

The workflow building component 410 may include a first monitoring component 413 for monitoring a user activity in the web browser session and a new activity component 414 for determining that a new activity in the web browser is activated by a user. The new activity component 410 may include an activity constraint component 419 for determining if a new activity satisfies defined domain constraints.

The workflow building component 410 may include a correlation component 420 for determining a correlation of the new activity with the root activity including an activity extraction component 421 for extracting some content from the web page of the new activity and a comparing component 422 for comparing it to the content of the root activity. The comparing component 422 may include a text similarity component 423 for comparing text similarity between the extracted content of the new activity and the extracted content of the root activity. The correlation component 420 may include a correlation refining component 425 for refining the correlation of the new activity with comparison with one or more previously saved activities.

The workflow building component 410 may include a saving component 416 for, if the correlation is above a threshold, saving the activity in the workflow to build a series of ordered activities. The workflow building component 410 may include a threshold configuration component 417 for allowing configuration of the threshold by the user to adjust the saving criteria for activities in a workflow.

The workflow building component 410 may include an end component 418 for receiving user input to declare an end to the workflow and storing the workflow for future use by the user or other users.

The workflow building component 410 may include a workflow management component 415 for managing saved workflows by editing the activities in a workflow and naming the workflow.

The workflow assistance system 405 may include a workflow suggestion component 430 including a second monitoring component 431 for monitoring a user activity in a web browser session for suggesting a next activity in a series of activities based on a saved workflow. The workflow suggestion component 430 may include an activity identifying component 432 for identifying an activity in a monitored user activity as similar to a root activity in a saved workflow and an activity suggestion component 433 suggesting a next activity in the saved workflow to the user.

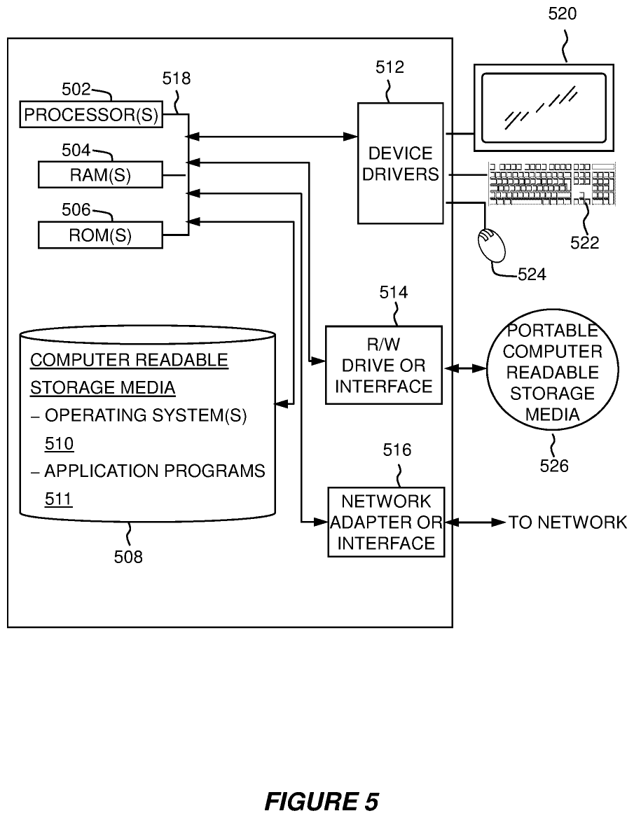

FIG. 5 depicts a block diagram of components of the computing device 400 of the workflow assistance system 405 of FIG. 4, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing device 400 can include one or more processors 502, one or more computer-readable RAMs 504, one or more computer-readable ROMs 506, one or more computer readable storage media 508, device drivers 512, read/write drive or interface 514, and network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within the system.

One or more operating systems 510, and application programs 511, such as workflow assistance applications are stored on one or more of the computer readable storage media 508 for execution by one or more of the processors 502 via one or more of the respective RAMs 504 (which typically include cache memory). In the illustrated embodiment, each of the computer readable storage media 508 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

Computing device 400 can also include a R/W drive or interface 514 to read from and write to one or more portable computer readable storage media 526. Application programs 511 on computing device 400 can be stored on one or more of the portable computer readable storage media 526, read via the respective R/W drive or interface 514 and loaded into the respective computer readable storage media 508.

Computing device 400 can also include a network adapter or interface 516, such as a TCP/IP adapter card or wireless communication adapter. Application programs 511 on computing device 400 can be downloaded to the computing device from an external computer or external storage device via a network (for example, the Internet, a local area network or other wide area networks or wireless networks) and network adapter or interface 516. From the network adapter or interface 516, the programs may be loaded into the computer readable storage media 508. The network may comprise copper wires, optical fibers, wireless transmission, routers, firewalls, switches, gateway computers and edge servers.

Computing device 400 can also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514, and network adapter or interface 516 can comprise hardware and software stored in computer readable storage media 508 and/or ROM 506.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

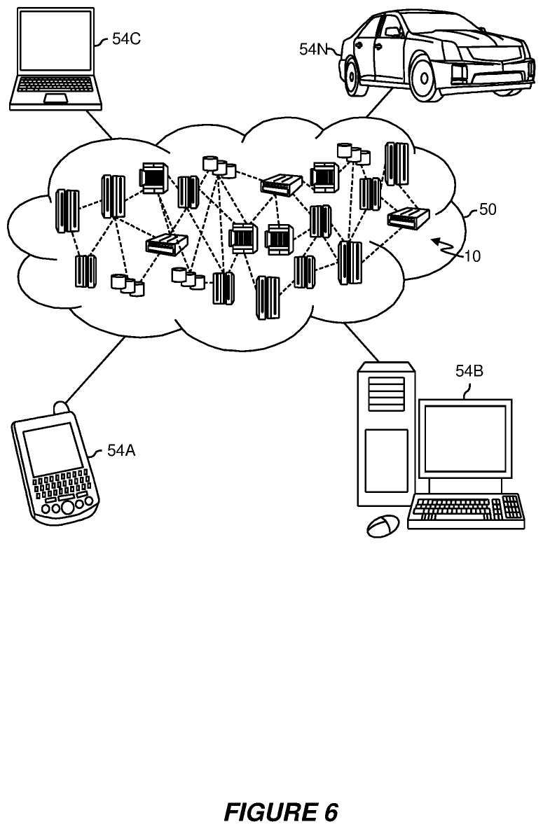

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

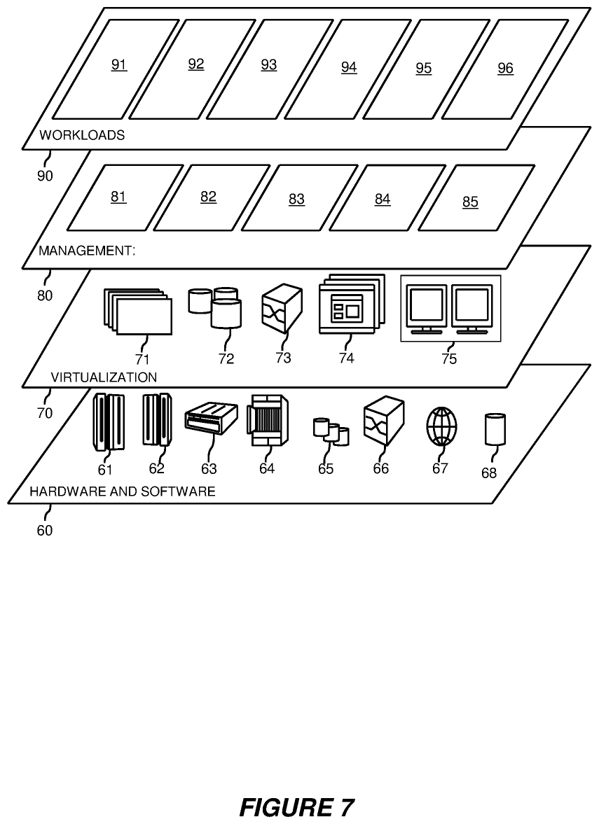

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform activities within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and activities, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workflow assistance processing 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method, comprising:
receiving from a user a declaration of a root activity in the web browser as the root of a workflow and extracting some content from a web page of the root activity;
monitoring a user activity in the web browser session and determining that a new activity in the web browser is activated by a user;
determining a correlation of the new activity with the root activity by extracting some content from the web page of the new activity and comparing it to the content of the root activity; and,
in response to the correlation being above a threshold, saving the activity in the workflow to build a series of ordered activities.

2. The method as claimed in claim 1, wherein an activity includes one of the group of:
accessing a web static or dynamic page, application or service, in a new window, page or tab of a web browser.

3. The method as claimed in claim 1, wherein determining a correlation compares the text similarity between the extracted content of the new activity and the extracted content of the root activity.

4. The method as claimed in claim 1, further comprising determining that a new activity satisfies defined domain constraints and ignoring the new activity if it satisfies domain constraints.

5. The method as claimed in claim 1, further comprising receiving user input to declare an end to the workflow and storing the workflow for future use by the user or other users.

6. The method as claimed in claim 1, further comprising refining the correlation of the new activity with comparison with one or more previously saved activities.

7. The method as claimed in claim 1, wherein the threshold is configurable by the user to adjust the saving criteria for activities in a workflow.

8. The method as claimed in claim 1, wherein saving the activity saves a Uniform Resource Locator with a generalized path.

9. The method as claimed in claim 1, further comprising managing saved workflows by editing the activities in a workflow and naming the workflow.

10. The method as claimed in claim 1, further comprising:
monitoring a user activity in a web browser session for suggesting a next activity in a series of activities based on a saved workflow;
identifying an activity in a monitored user activity as similar to a root activity in a saved workflow; and
suggesting a next activity in the saved workflow to the user.

11. The method as claimed in claim 10, wherein identifying an activity as similar to a root activity compares the Uniform Resource Locator of the activity with a saved Uniform Resource Locator and disregarding some of the locator path suffix to generalize the Uniform Resource Locator.

12. A system, comprising:
a processor and a memory configured to provide computer program instructions to the processor to execute the function of components;
a workflow building component including:
a root activity component for receiving from a user a declaration of a root activity in the web browser as the root of a workflow and a root extraction component for extracting some content from a web page of the root activity;
a first monitoring component for monitoring a user activity in the web browser session and a new activity component for determining that a new activity in the web browser is activated by a user;
a correlation component for determining a correlation of the new activity with the root activity including an activity extraction component for extracting some content from the web page of the new activity and a comparing component for comparing it to the content of the root activity; and,
a saving component for, if the correlation is above a threshold, saving the activity in the workflow to build a series of ordered activities.

13. The system as claimed in claim 12, further comprising a workflow suggestion component including:
a second monitoring component for monitoring a user activity in a web browser session for suggesting a next activity in a series of activities based on a saved workflow;
an activity identifying component for identifying an activity in a monitored user activity as similar to a root activity in a saved workflow; and
an activity suggestion component for suggesting a next activity in the saved workflow to the user.

14. The system as claimed in claim 12, wherein the comparing component includes a text similarity component for comparing text similarity between the extracted content of the new activity and the extracted content of the root activity.

15. The system as claimed in claim 12, further comprising an activity constraint component for determining if a new activity satisfies defined domain constraints.

16. The system as claimed in claim 12, including an end component for receiving user input to declare an end to the workflow and storing the workflow for future use by the user or other users.

17. The system as claimed in claim 12, wherein the correlation component includes a correlation refining component for refining the correlation of the new activity with comparison with one or more previously saved activities.

18. The system as claimed in claim 12, including a threshold configuration component for allowing configuring the threshold by the user to adjust the saving criteria for activities in a workflow.

19. The system as claimed in claim 12, including a workflow management component for managing saved workflows by editing the activities in a workflow and naming the workflow.

20. A computer program product, the computer program product comprising a computer readable storage medium having program instructions embodied therewith, the program instructions executable by a processor to cause the processor to:
receive from a user a declaration of a root activity in the web browser as the root of a workflow and extract some content from a web page of the root activity;
monitor a user activity in the web browser session and determine that a new activity in the web browser is activated by a user;
determine a correlation of the new activity with the root activity by extracting some content from the web page of the new activity and compare it to the content of the root activity; and,
if the correlation is above a threshold, save the activity in the workflow to build a series of ordered activities.
